(19) United States
(12) Patent Application Publication
(10) Pub. No.: US 2021/0262432 A1
(43) Pub. Date: Aug. 26, 2021

(54) Precipitation and Conveyor System Operated Electrical Generation System

(71) Applicant: Leonard Eva, Calgary (CA)

(72) Inventor: Leonard Eva, Calgary (CA)

(21) Appl. No.: 17/060,035

(22) Filed: Sep. 30, 2020

Related U.S. Application Data
(60) Provisional application No. 62/979,539, filed on Feb. 21, 2020.

(51) Int. Cl. F03B 17/06; B65G 17/12; B65G 47/58; H02K 7/18

(52) U.S. Cl. CPC F03B 17/066; H02K 7/1853; B65G 47/58; B65G 17/12

(57) ABSTRACT

A precipitation and conveyor operated electrical generation system has a conveyor system, at least one electrical generator, and at least one storage container. Each electrical generator is operatively connected to the conveyor system, such at each electrical generator is operated through motion of the conveyor system. The conveyor system may have multiple conveyor tracks, each having a plurality of conveyor containers that are distributed along, connected to, and configured to circuitously traverse about their corresponding conveyor track. At least one dispensing container of the at least one storage container is configured to receive a quantity of precipitation and dispense the quantity of precipitation into one of the conveyor tracks of the conveyor system. The dispensed precipitation causes motion of the conveyor system and operation of the at least one electrical generator.

The current application claims a priority to the U.S. Provisional Patent application Ser. No. 62/979,539 filed on Feb. 21, 2020.

### FIELD OF THE INVENTION

The present invention relates generally to electrical generation. More specifically, the present invention relates to a hydropower system that uses and relocates precipitation collected from incident weather conditions.

### BACKGROUND OF THE INVENTION

Hydropower is one of the most environmentally friendly sources of electricity. Moving water can be used by hydroelectric generators to generate electricity. However, it is difficult to use traditional hydroelectric generators to power a house. Traditional hydroelectric generators such as a turbine or a water wheel need a constant stream of water to generate electricity, something that is not readily available for many residential areas.

One alternative source of moving water that can be used by a hydroelectric generator is collected rainwater. Rainwater can be collected from a sloped surface such as a rooftop before flowing into a hydroelectric generator. Currently, there are hydropower systems for powering a house that use collected rainwater. However, none of these systems can deliver the collected rainwater to a set location after the rainwater has flowed through the hydroelectric generator. This means that the rainwater is wasted after it has been used to power a house. As a result, there is a need for a system for powering a residential building using rainwater without wasting it.

In the preferred embodiment, the present invention is an electrical power system that uses and relocates rainwater. The electrical power system can guide the collected rainwater to a set location after the rainwater has been used to generate electricity. The electrical power system has a belt conveyor system with containers attached to the top of the conveyor belt and an electrical generator. The belt conveyor system is angled at a downward angle to direct the collected rainwater to a set location. The containers attached to the conveyor belt can be filled with collected rainwater. After a container has been filled up with collected rainwater, the filled-up container moves downwards under the influence of gravity and forces the conveyor belt to rotate. The rotation of the conveyor belt is then converted into electricity by the electrical generator.

Once the filled-up container reaches the bottom of the belt conveyor system, the container can be emptied into a storage tank. The container can then travel back up on the opposite side of the belt conveyor system before being filled up with rainwater.

In one alternative embodiment of the invention, the electrical power system uses collected snow to generate electricity.

In another alternative embodiment of the invention, multiple belt conveyor systems can be used to move the collected precipitation.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is an illustration of an embodiment of the present invention with a single conveyor track.

FIG. 2 is an illustration of an embodiment of the present invention with multiple conveyor tracks.

FIG. 3 is an illustration of an embodiment of the present invention with an arbitrary number of conveyor tracks.

FIG. 4 is an illustration of an embodiment of the present invention configured to use snow as the quantity of precipitation.

FIG. 5 is an illustration of an embodiment of the present invention with multiple vertically overlapping conveyor tracks.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is an electrical generation system for providing electrical power to a building or other entity for consumption. The system of the present invention utilizes precipitation collected from ambient weather conditions to generate electricity and relocate the collected precipitation to a set location.

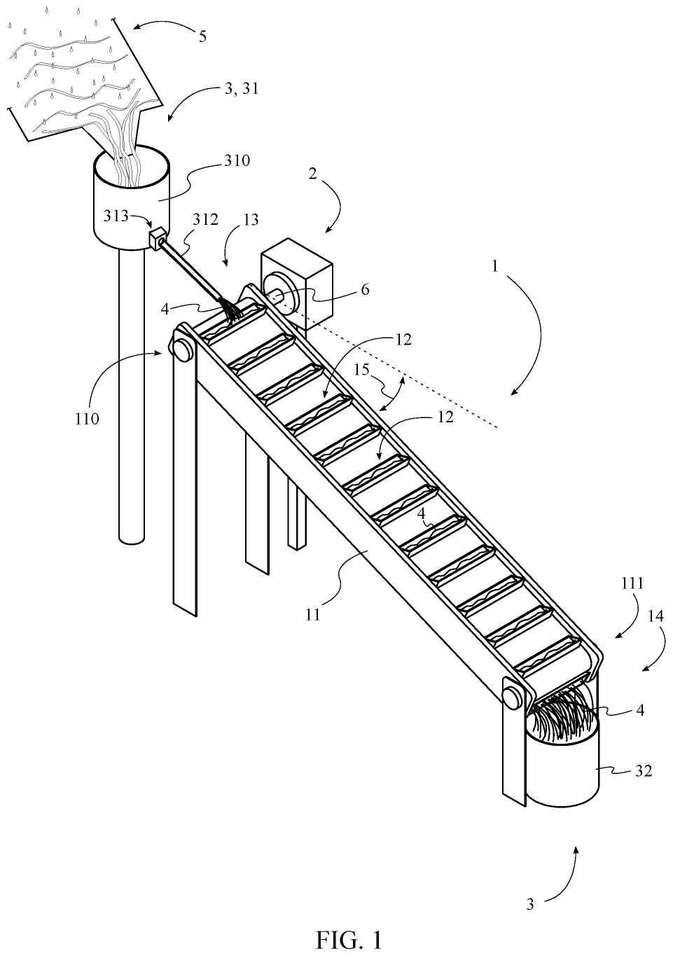

In general, referring to FIG. 1, the present invention comprises a conveyor system 1, at least one electrical generator 2, and at least one storage container 3. Each storage container 3 serves to receive, store, and/or dispense or otherwise regulate the displacement of water collected in the form of precipitation along the conveyor system 1 in order to operate the at least one electrical generator 2. The collected precipitation is dispensed into the conveyor system 1, whereby the force of gravity of the precipitation exerted on the conveyor system 1 causes motion of the conveyor system 1, which in turn operates the at least one electrical generator 2 to generate electrical power. The generated electrical power may be used by, stored in, or transferred to any destination as desired. One use of the water collected and electricity produced is to connect the system to an electrolyzer component in order to obtain liquid hydrogen. Some of the ‘fuel’ obtained can power a utility vehicle such as a Bobcat or other applications discussed further on herein in order to fill up the conveyor through means besides the primary method of collecting precipitation. Primarily, the present invention is focused on the collected precipitation being liquid water in the form of rain, though alternative embodiments are contemplated herein which similarly utilize snow or other solid forms of precipitation as the collected precipitation.

The at least one electrical generator 2 may be a single electrical generator or may comprise multiple electrical generators in various embodiments as desired. Each electrical generator is operatively connected to the conveyor system 1, wherein each electrical generator is operated through motion of the conveyor system 1.

More specifically, the preferred embodiment of the present invention further comprises at least one output shaft 6, with each output shaft being operatively connected between the conveyor system 1 and one of the at least one electrical generator 2. As such, the conveyor system 1 is configured to operate the at least one electrical generator 2 through the at least one output shaft 6, wherein linear motion of the conveyor system 1 is converted to rotational motion at the at least one output shaft 6 in order to operate the at least one electrical generator 2. It is contemplated, however, that the present invention may utilize any suitable means to convert motion of the conveyor system 1 into electricity.

The conveyor system 1 comprises at least one conveyor track 11 and at least one plurality of conveyor containers 12, wherein each of the at least one conveyor track 11 extends between an input end 110 and an output end 111, and wherein the conveyor system 1 traverses from a loading end 13 to a discharge end 14. In some embodiments of the present invention, the conveyor system 1 may utilize only a single conveyor track. In such embodiments, the input end 110 of the single conveyor track corresponds to the loading end 13 of the conveyor system 1, while the output end 111 of the single conveyor track corresponds to the discharge end 14. In some embodiments, the conveyor system 1 may comprise multiple conveyor tracks arranged together in sequence. It should be understood that in the preferred embodiment, each conveyor track is circuitous in geometry, facilitating continuous and cyclical motion of conveyor containers along its length.

In the preferred embodiment of the present invention, the at least one electrical generator 2 is operated through motion of the at least one conveyor track 11. Each output shaft is operatively coupled to one of the at least one conveyor track 11, such that the linear motion of the at least one conveyor track 11 is converted to rotational motion of the at least one output shaft 6. This functionality may be facilitated through any suitable arrangement in various embodiments. For example, in some embodiments, the conveyor tracks and the output shafts may interface through mating sets of gear teeth similar to a rack and pinion mechanism, or through a chain and sprocket-like mechanism, or through frictional engagement, or any other suitable means. In some embodiments, each conveyor container may instead be operatively connected to an output shaft, such that the motion of the conveyor containers, as opposed to the conveyor track itself, turns operates the electrical generator. Preferably, each electrical generator will have additional regulating components such as, but not limited to, an electrical variance regulator and a speed controller.

The conveyor system 1 is oriented at a downward inclination angle 15 in order to harness the force of gravity to operate the conveyor system 1 and thusly operate the at least one electrical generator 2. More specifically, the loading end 13 of the conveyor system 1 is positioned at a higher elevation than the discharge end 14 of the conveyor system 1. Furthermore, for each of the at least one conveyor track 11, the input end 110 is positioned at a higher elevation than the output end 111.

Each of the at least one plurality of containers is distributed along and connected to a corresponding track from the at least one conveyor track 11, wherein each of the at least one plurality of conveyor containers 12 is configured to circuitously traverse about the corresponding track. The functional role of the conveyor containers in the present invention is to receive a quantity of precipitation 4 and transmit the force due to gravity of the quantity of precipitation 4 to a conveyor track, resulting in motion of the conveyor track. Motion of the at least one plurality of conveyor containers 12 about the at least one conveyor track 11 is configured to rotate the at least one output shaft 6 and operate the at least one electrical generator 2. Each conveyor container receives a quantity of precipitation 4 at the input end 110 of its corresponding track, traverses along the corresponding track toward the output end 111 of the corresponding track, and discharges the quantity of precipitation 4 at the output end 111. The specific means of discharge at the output end 111 of the quantity of precipitation 4 may vary in different embodiments, but may generally be understood to be accomplished through rotation of the conveyor container as it rounds the output end 111 of the corresponding track such that the contained precipitation spills from the edges of the conveyor container's open top.

It should be noted that references herein to a “quantity of precipitation” are generally used as a generic term and are not necessarily considered to refer to any particular unit of precipitation unless otherwise noted.

Each conveyor track comprised in a given embodiment necessitates the use of its own set, or subset, of conveyor containers; in embodiments with a single conveyor track, a single plurality, or set, of conveyor containers will be comprised. In embodiments with multiple conveyor tracks, multiple sets of conveyor containers will be comprised, with each set of conveyor containers being connected to one of the conveyor tracks. Thus, in embodiments comprising a plurality of conveyor tracks, a plurality of pluralities of conveyor containers will correspondingly be comprised, with each of the plurality of pluralities of conveyor containers corresponding to one of the plurality of conveyor tracks. For example, a single conveyor track may have ten conveyor containers. This set of ten conveyor containers is one plurality of conveyor containers. Moreover, in this example, the conveyor system 1 may have three conveyor tracks, each having their own set of ten conveyor containers, for a total of thirty conveyor containers, divided into three sets of ten, or a plurality (three) of pluralities (ten) of conveyor containers.

The specific configuration of and the connection between the conveyor containers and the conveyor track may vary in different embodiments, so long as the force due to gravity exerted by a quantity of precipitation 4 upon the conveyor container in which the quantity of precipitation 4 is contained causes motion of the conveyor system 1, resulting in rotation of an output shaft and thus operation of one of the at least one electrical generator 2.

In the preferred embodiment of the present invention, each conveyor container is affixed to one of the conveyor tracks at a specific container angle relative to the container track in order to facilitate optimal filling, transport and discharging of the quantity of precipitation 4 into and from the conveyor containers.

In some embodiments, each conveyor track comprises a conveyor belt and a support frame. The support frame may vary in different embodiments as desired; for example, in some embodiments, the support frame may comprise a plurality of rollers which support the conveyor belt. Alternatively, for example, in some embodiments, the conveyor track may be composed of many track segments connected hingedly and serially together, with each track segment being supported by wheels which captively roll along wheel-receiving channels of the support frame. The aforementioned configurations are presented herein solely as exemplary embodiments and are not intended to be limiting, and it may be understood that any suitable arrangements may be realized for the at least one conveyor track 11 to fulfill the spirit and scope of the present invention.

The preferred embodiment of the present invention further comprises a precipitation collection area 5. The precipitation collection area 5 should be open to receiving falling precipitation and have a large horizontal cross section in order to capture as much falling precipitation as possible or needed to operate the conveyor system 1. In some embodiments, the precipitation collection area 5 may be a container with an open top. In some embodiments, the precipitation collection area 5 may be a generally wide, flat surface that is sloped or otherwise configured to drain toward a specific point in order to transfer the collected precipitation to the conveyor system 1. In some embodiments, the precipitation collection area 5 may furthermore be lined with solar panels to harvest additional solar energy.

As previously mentioned, the preferred embodiment of the present invention incorporates multiple storage containers, with each storage container serving to receive, store, and/or dispense or otherwise regulate transferal of water collected in the form of precipitation along the conveyor system 1 in order to operate the at least one electrical generator 2. The at least one storage container 3 comprises at least one dispensing container 31. Each of the at least one dispensing container 31 is positioned adjacent to the input end 110 of a corresponding track from the at least one conveyor track 11, and each of the at least one dispensing container 31 is configured to receive a quantity of precipitation 4 and dispense the quantity of precipitation 4 into an arbitrary container from the plurality of conveyor containers of the corresponding track at the input and of the corresponding track, wherein the arbitrary container is displaced from the input end 110 toward the output end 111 by the weight of the quantity of precipitation 4.

Each dispensing container serves as a reservoir of water, initially collected as precipitation at the precipitation collection area 5, which is dispensed into the conveyor containers of one of the at least one conveyor track 11. In a way, the collected precipitation acts as a “fuel” which is used to operate the conveyor system 1, and the dispensing containers act as “fuel” tanks which store and dispense the “fuel.” The dispensing containers should be large enough to contain an amount of precipitation greater than is necessary to operate the conveyor system 1 at any given moment, while being capable of dispensing the water into the conveyor system 1 at a consistent rate for continuous, consistent operation of the conveyor system 1.

Furthermore, in the preferred embodiment, each of the at least one dispensing container 31 comprises a discharge conduit 312, the discharge conduit 312 being positioned adjacent to the input end 110 of the corresponding track for each of the at least one dispensing container 31. The discharge conduit 312 serves to guide the quantity of precipitation 4 into the correct destination relative to the corresponding track upon discharge from the dispensing container. The discharge conduit 312 may take various forms in different embodiments. In some embodiments, the discharge conduit 312 may be a pipe, nozzle, spout, or similar apparatus. In some embodiments, the discharge conduit 312 may more closely resemble a gutter or duct, in embodiments intended to utilize snow or similar solid or granular forms of precipitation.

In the preferred embodiment, the at least one dispensing container 31 comprises an input dispensing container 310, which is positioned at the loading end 13 of the conveyor system 1. The precipitation collection area 5 is therefore configured to receive the quantity of precipitation 4 and dispense the quantity of precipitation 4 into the input dispensing container 310. The input dispensing container 310 is furthermore configured to receive the quantity of precipitation 4 from the precipitation collection area 5 and dispense the quantity of precipitation 4 into a first conveyor track 112 from the at least one conveyor track 11. More specifically, the input dispensing container 310 is configured to receive the quantity of precipitation 4 from the precipitation collection area 5 and dispense the quantity of precipitation 4 into at least one of the plurality of conveyor containers of the first conveyor track 112. It should be noted that the action of dispensing as used herein may refer to a passive event, such as water flowing through a drain hole, pipe or spout due to gravity, or to an actively taken action, such as a mechanical discharge of water through a pumping apparatus.

In the preferred embodiment, the at least one storage container 3 further comprises a discharge storage container 32. The discharge storage container 32 is positioned adjacent to the output end 111 of the last conveyor track 113, wherein the quantity of precipitation 4 is discharged from the plurality of conveyor containers of the last conveyor track 113 into the discharge storage container 32. After a conveyor container of the last conveyor track 113 has been loaded at the input end 110 of the last conveyor track 113, traverses along the last conveyor track 113, and arrives at the output end 111 of the last conveyor track 113, its contents are deposited into the discharge storage container 32.

In the preferred embodiment of the present invention, it is desired to specifically regulate one or more aspects of the discharging of the quantity of precipitation 4 from the at least one dispensing container 31 into its corresponding conveyor track; or more specifically, from the at least one dispensing container 31 into one or more of the plurality of conveyor containers of its corresponding conveyor track.

To this end, in the preferred embodiment, each of the at least one dispensing container 31 further comprises a flow regulating mechanism 313, the flow regulating mechanism 313 being operatively connected to, and/or integrated into, the discharge conduit 312. The flow regulating mechanism 313 is configured to dispense a specific quantity of precipitation 4 through the discharge conduit 312 into at least one of the conveyor containers of the corresponding track for each of the at least one dispensing container 31. It may be desirable in different embodiments to specifically control various attributes of the flow of precipitation dispensed into the conveyor containers, such as, but not limited to, pressure, velocity, mass flow rate, discharge time duration, angle, or other attributes in order to properly control the downward force applied to the conveyor track by the quantity of precipitation 4 and therefore the speed at which the conveyor track moves. Furthermore, an electronic control unit may be employed to periodically switch on and off the discharge of precipitation through the discharge conduit 312 in order to ensure that the discharged precipitation lands only within the conveyor containers and is not needlessly wasted by spilling through any empty space between conveyor containers.

In some embodiments, the discharge conduit 312 may be oriented at a specified angle 300. By orienting the discharge conduit 312 at a specified angle 300, the quantity of precipitation 4 discharged from the discharge conduit 312 may be made to strike the interior of a conveyor container with a certain velocity and thus add propelling force to the motion of the conveyor track to supplement the force supplied by the weight of the quantity of precipitation 4.

As previously described, the present invention may utilize a single conveyor track or multiple conveyor tracks arranged in series. In embodiments with multiple conveyor tracks, one of the at least one dispensing container 31 is positioned between conveyor tracks and serves to regulate the passage of precipitation from one conveyor track 11 to the next.

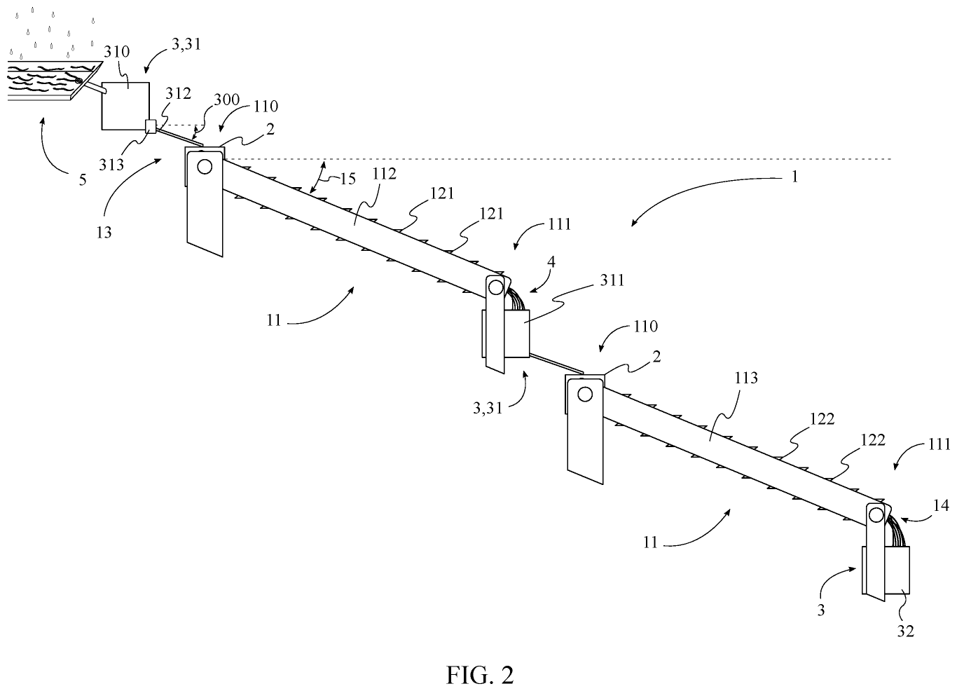

Referring to FIG. 2, in embodiments with multiple conveyor tracks, the at least one conveyor track 11 comprises a first conveyor track 112 and a last conveyor track 113, wherein the at least one conveyor track 11 is arranged in series from the first conveyor track 112 to the last conveyor track 113. Furthermore, the at least one plurality of conveyor containers 12 comprises a first plurality of conveyor containers 121 and a last plurality of conveyor containers 122, while the at least one dispensing container 31 comprises an input dispensing container 310 and a last dispensing container 311.

The input end 110 of the first conveyor track 112 is positioned adjacent to the loading end 13 of the conveyor system 1. The first plurality of conveyor containers 121 is distributed along and connected to the first conveyor track 112, wherein each of the first plurality of conveyor containers 121 is configured to circuitously traverse about the first conveyor track 112. The input dispensing container 310 is positioned adjacent to the input end 110 of the first conveyor track 112. The input dispensing container 310 is configured to receive the quantity of precipitation 4 and dispense the quantity of precipitation 4 into at least one of the first plurality of conveyor containers 121.

The output end 111 of the last conveyor track 113 is positioned adjacent to the discharge end 14 of the conveyor system 1. The last plurality of conveyor containers 122 is distributed along and connected to the last conveyor track 113, wherein each of the last plurality of conveyor containers 122 is configured to circuitously traverse about the last conveyor track 113. The last dispensing container 311 is positioned adjacent to the input end 110 of the last conveyor track 113, and the last dispensing container 311 is configured to receive the quantity of precipitation 4 and dispense the quantity of precipitation 4 into at least one of the last plurality of conveyor containers 122.

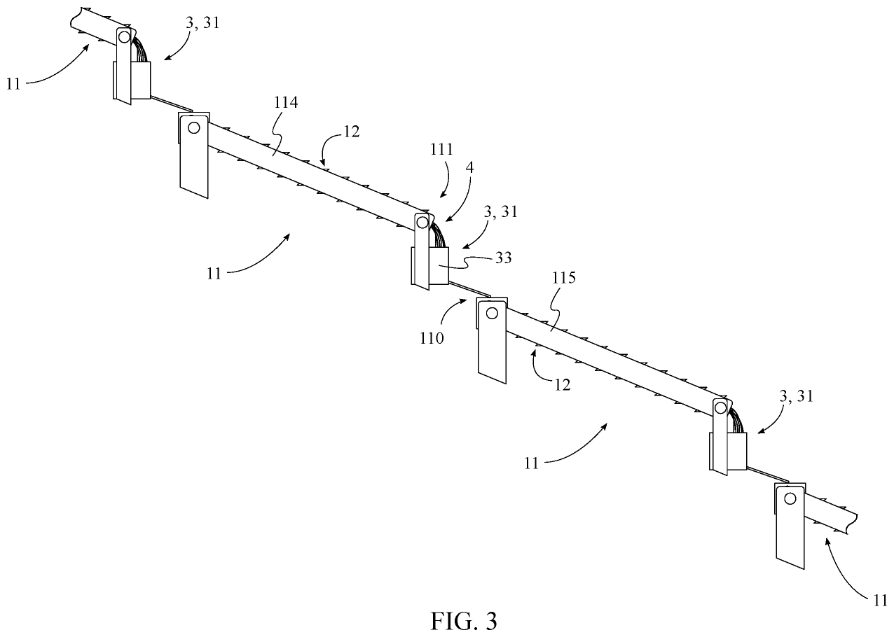

Referring to FIG. 3, in some embodiments, the at least one conveyor track 11 comprises an arbitrary conveyor track 114 and an adjacent conveyor track 115, wherein the arbitrary conveyor track 114 and the adjacent conveyor track 115 are arranged sequentially in the conveyor system 1, with the adjacent conveyor track 115 succeeding the arbitrary conveyor track 114 in the sequential arrangement. Moreover, the at least one storage container 3 may further comprise at least one intermediate container 33. The intermediate container 33 is positioned between the output end 111 of the arbitrary conveyor track 114 and the input end 110 of the adjacent conveyor track 115, wherein the at least one intermediate container 33 is configured to receive the quantity of precipitation 4 from the arbitrary conveyor track 114 and dispense the quantity of precipitation 4 onto the adjacent conveyor track 115.

After precipitation has traversed through the conveyor system 1 and been discharged into the discharge container, the contents of the discharge container may subsequently be transferred into a water tank truck, transported back to the loading end 13 of the conveyor system 1, and transferred back into the input dispensing container 310 for re-use. This will make it possible for the system of the present invention to operate continuously even during period with no incident precipitation.

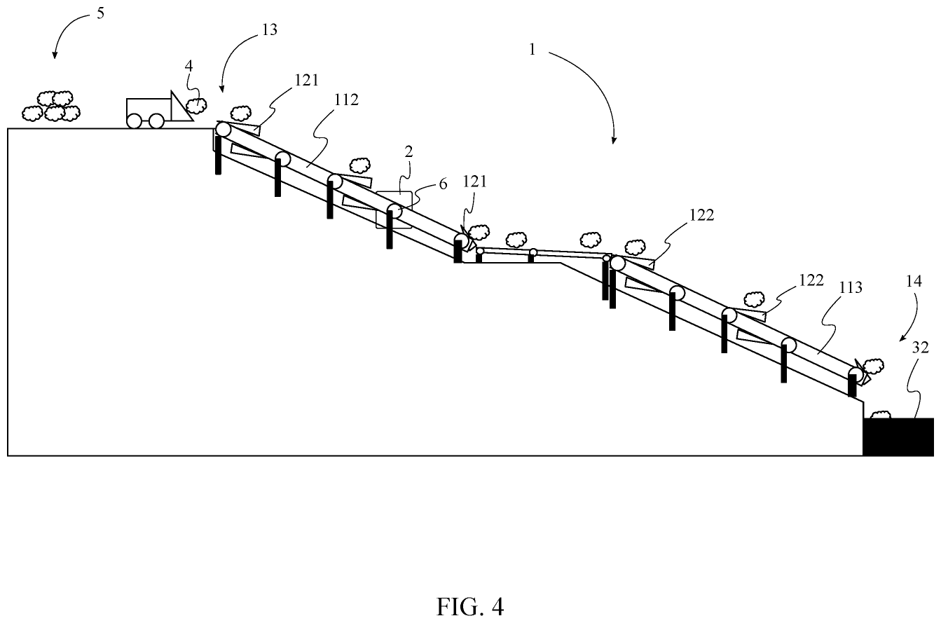

As previously mentioned, in some embodiments, as illustrated in FIG. 4, the present invention may be adapted to use snow or other solid or granular forms of precipitation. Since, unlike liquid water, snow is resistant to flowing under the force due to gravity, it may be necessary to manually load the conveyor system 1 with snow at the loading end 13 through the use of a loader vehicle such as a Bobcat utility vehicle or some other relevant implement or means. In such embodiments, the precipitation collection area 5 may still be comprised, but transferal of the solid precipitation onto the conveyor system 1 may necessitate use of said loader vehicle such as a Bobcat utility vehicle, or automated mechanical displacement means, or other applicable means. In such embodiments, the at least one dispensing container 31 may not be comprised.

In some embodiments, a precipitation portioning mechanism may be comprised between the precipitation collection area 5 and the conveyor system 1. In general, the precipitation portioning mechanism should be understood to be configured to portion out a quantity of solid precipitation from a larger mass of solid precipitation and discharge the quantity of solid precipitation into the conveyor system 1. The precipitation portioning mechanism may vary in different embodiments. In some embodiments, the precipitation portioning mechanism may utilize a rotating cylinder. In some embodiments, the precipitation portioning mechanism may utilize a conveyor screw that it turned at specified intervals.

In such embodiments, storage containers may not need to be comprised between successive conveyor tracks, and one conveyor track 11 may simply transfer its contents directly onto its successor. After the solid precipitation reaches the discharge end 14 of the conveyor system 1 and is discharged into the discharge storage container 32, a loader vehicle or other mechanical means may be utilized to transfer the solid precipitation back to the loading end 13 of the conveyor system 1 for re-use. While this ultimately is a loss of energy considering the sum total of energy produced by the conveyor system 1 minus the energy required to transport the solid precipitation back to the loading end 13, it may be a useful practice in some instances due to differing sources and uses of energy. For example, a loader vehicle might expend the energy of liquid hydrogen, gasoline or diesel fuel to transport the solid precipitation back to the loading end 13, while the electricity generated by the system might be used by a building or stored in a battery bank which would not be powered by the same type of fuel as the loader vehicle.

In some embodiments, the present invention is adaptable between the use of liquid and solid precipitation for use in warmer and colder times of the year. To this end, each conveyor container may be configured to be detached from its respective conveyor track and replaced with a different conveyor container with a different configuration. For example, conveyor containers intended for use with snow may be larger than conveyor containers intended for use with rain.

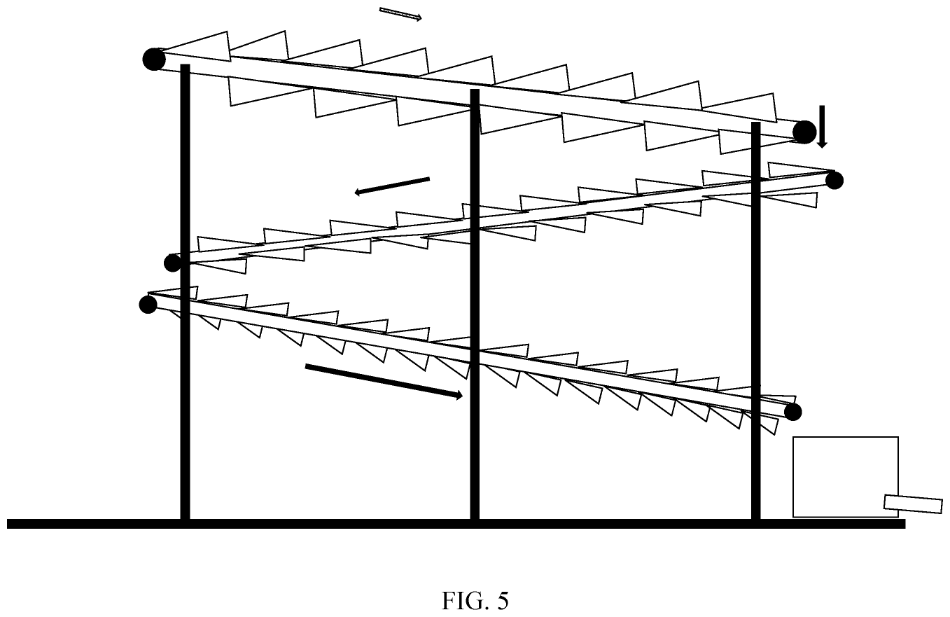

In some embodiments, as illustrated in FIG. 5, the conveyors can alternatively be deployed in a vertically overlapping configuration, with one underneath the other. In this way, if the precipitation collection area is situated at a certain height, the system can contain multiple layers of conveyors within the same footprint on the ground.

Another use of the present invention could be to complete the cycle renewable energy through recycling material to ultimately produce oxygen.

Part of the energy produced by this system may be used to obtain small size shapes from recycled materials and nutrients. In each shape a tree seed is inserted. The seeds can be deployed in large quantities in order to reforest large areas. This will produce oxygen.

The following is an alternate description of the present invention and should not be considered to be limiting, but rather exemplary in order to further illustrate the spirit and scope of the present invention.

The present invention is an electrical generator system for powering a building. The system can use precipitation collected from weather conditions to generate electricity and relocate the collected precipitation to a set location. To accomplish this, the system can comprise a belt conveyor system, a plurality of containers, and at least one electrical generator.

In order to generate electricity using precipitation collected from various weather conditions, a member of the plurality of the containers must first be filled up with the collected precipitation at the top of the belt conveyor system. The plurality of containers is attached to a belt conveyor system that is oriented at a downwards angle. The orientation of the belt conveyor system allows the filled up member of the plurality of containers to move towards the bottom of the belt conveyor system under the influence of gravity. Once the filled up member reaches the bottom of the belt conveyor system, the filled up member empties the collected precipitation into a storage basin. The now emptied member can be moved back towards the top of belt conveyor system by filling up another member of the plurality of container at the top of the belt conveyor system. At least one electrical generator is operatively coupled to the belt conveyor system, allowing the cyclical movement of the plurality of containers to be converted into electrical energy.

The plurality of containers is attached to the moving portion of the belt conveyor system, allowing the plurality of containers to move in a cyclical manner. The belt conveyor system can comprise a set of legs, a conveyor belt, and a plurality of rollers supporting the conveyor belt. The set of legs support the belt conveyor system at a downward angle. The plurality of containers is attached to the conveyor belt preferably with bolts. The attachment of the containers to the conveyor belt forces the conveyor belt and the plurality of rollers to rotate with the cyclical movement of the plurality of containers. Each member of the plurality of containers can further be fixed to the belt conveyor system at the same angle. The fixed orientation ensures each member can be filled up and emptied while the belt conveyor system is cycling the plurality of containers.

The rotation of at least one member of the plurality of rollers can be used to generate electricity. This is accomplished by having at least one electrical generator attached to a corresponding member of the plurality of rollers. The forced rotation of a member of the plurality of rollers is converted into electricity by the attached electrical generator.

In the preferred embodiment, the system uses collected rainwater to generate electricity. Rainwater is first collected in the storage tank before being dispensed into the plurality of containers at fixed intervals to avoid wasting water. The storage tank can comprise a spout, a chamber and a regulating mechanism. The chamber of the storage tank is open and can collect rainwater. The regulating mechanism controls how much collected rainwater in the chamber is emptied by the spout. The regulating mechanism allows the spout to empty collected rainwater from the chamber at controlled intervals to ensure collected rainwater is only being dispersed into the plurality of containers.

In one alternative embodiment, the system can use collected snow to generate electricity. The snow can be dispensed into a member of the plurality of containers. Once a member of the plurality of containers is filled up with snow, the filled up member can travel down the conveyor belt and be emptied.

In another alternative embodiment, the system can use multiple belt conveyor systems to move the collected precipitation to a set location. The storage basin is replaced with another storage tank, allowing the collected precipitation to move across multiple belt conveyor systems.

Although the invention has been explained in relation to its preferred embodiment, it is to be understood that many other possible modifications and variations can be made without departing from the spirit and scope of the invention as hereinafter claimed.

What is claimed is:

1. A precipitation and conveyor operated electrical generation system comprising:
a conveyor system;
at least one electrical generator;
at least one storage container;
each electrical generator being operatively connected to the conveyor system, wherein each electrical generator is operated through motion of the conveyor system;
the conveyor system comprising at least one conveyor track and at least one plurality of conveyor containers;
each of the at least one conveyor track extending between an input end and an output end;
the conveyor system traversing from a loading end to a discharge end;
the conveyor system being oriented at a downward inclination angle, wherein the loading end of the conveyor system is positioned at a higher elevation than the discharge end of the conveyor system, and wherein the input end is positioned at a higher elevation than the output end for each of the at least one conveyor track;
each of the at least one plurality of conveyor containers being distributed along and connected to a corresponding track from the at least one conveyor track, wherein each of the at least one plurality of conveyor containers is configured to circuitously traverse about the corresponding track;
the at least one storage container comprising at least one dispensing container;
each of the at least one dispensing container being positioned adjacent to the input end of a corresponding track from the at least one conveyor track; and
each of the at least one dispensing container being configured to receive a quantity of precipitation and dispense the quantity of precipitation into an arbitrary container from the plurality of conveyor containers of the corresponding track at the input end of the corresponding track, wherein the arbitrary container is displaced from the input end toward the output end by the weight of the quantity of precipitation.

2. The precipitation and conveyor system operated electrical generation system as claimed in claim 1 comprising:
the at least one conveyor track comprising a first conveyor track and a last conveyor track, wherein the at least one conveyor track is arranged in series from the first conveyor track to the last conveyor track;
the at least one plurality of conveyor containers comprising a first plurality of conveyor containers and a last plurality of conveyor containers;
the at least one dispensing container comprising an input dispensing container and a last dispensing container;
the input end of the first conveyor track being positioned adjacent to the loading end of the conveyor system;
the first plurality of conveyor containers being distributed along and connected to the first conveyor track, wherein each of the first plurality of conveyor containers is configured to circuitously traverse about the first conveyor track;
the input dispensing container being positioned adjacent to the input end of the first conveyor track;
the input dispensing container being configured to receive the quantity of precipitation and dispense the quantity of precipitation into at least one of the first plurality of conveyor containers;
the output end of the last conveyor track being positioned adjacent to the discharge end of the conveyor system;
the last plurality of conveyor containers being distributed along and connected to the last conveyor track, wherein each of the last plurality of conveyor containers is configured to circuitously traverse about the last conveyor track;
the last dispensing container being positioned adjacent to the input end of the last conveyor track; and
the last dispensing container being configured to receive the quantity of precipitation and dispense the quantity of precipitation into at least one of the last plurality of conveyor containers.

3. The precipitation and conveyor system operated electrical generation system as claimed in claim 2 comprising:
the at least one storage container further comprising a discharge storage container; and
the discharge storage container being positioned adjacent to the output end of the last conveyor track, wherein the quantity of precipitation is discharged from the plurality of conveyor containers of the last conveyor track into the discharge storage container.

4. The precipitation and conveyor system operated electrical generation system as claimed in claim 1 comprising:
a precipitation collection area;
the at least one dispensing container comprising an input dispensing container;
the input dispensing container being positioned at the loading end of the conveyor system;
the precipitation collection area being configured to receive the quantity of precipitation and dispense the quantity of precipitation into the input dispensing container; and
the input dispensing container being configured to receive the quantity of precipitation from the precipitation collection area and dispense the quantity of precipitation into a first conveyor track from the at least one conveyor track.

5. The precipitation and conveyor system operated electrical generation system as claimed in claim 1 comprising:
at least one output shaft;
each output shaft being operatively connected between the conveyor system and one of the at least one electrical generator; and
the conveyor system being configured to operate the at least one electrical generator through the at least one output shaft, wherein motion of the at least one plurality of conveyor containers about the at least one conveyor track is configured to rotate the at least one output shaft.

6. The precipitation and conveyor system operated electrical generation system as claimed in claim 1 comprising:
each of the at least one dispensing container comprising a discharge conduit; and
the discharge conduit being positioned adjacent to the input end of the corresponding track and oriented toward the corresponding track for each of the at least one dispensing container.

7. The precipitation and conveyor system operated electrical generation system as claimed in claim 6 comprising:
each of the at least one dispensing container further comprising a flow regulating mechanism;
the flow regulating mechanism being operatively connected to the discharge conduit; and
the flow regulating mechanism being configured to dispense a specific quantity of precipitation through the discharge conduit into at least one of the conveyor containers of the corresponding track for each of the at least one dispensing container.

8. The precipitation and conveyor system operated electrical generation system as claimed in claim 6 comprising:
the discharge conduit being oriented at a specified angle.

9. The precipitation and conveyor system operated electrical generation system as claimed in claim 1 comprising:
the at least one conveyor track comprising an arbitrary conveyor track and an adjacent conveyor track, wherein the arbitrary conveyor track and the adjacent conveyor track are arranged sequentially in the conveyor system;
the at least one storage container further comprising at least one intermediate container;
the at least one intermediate container being positioned between the output end of the arbitrary conveyor track and the input end of the adjacent conveyor track; and
the at least one intermediate container being configured to receive the quantity of precipitation from the arbitrary conveyor track and dispense the quantity of precipitation onto the adjacent conveyor track.
